(19) United States
(12) Patent Application Publication
(10) Pub. No.: US 2022/0083051 A1
(43) Pub. Date: Mar. 17, 2022

(54) SYSTEM FOR SAFE TELEOPERATED DRIVING

(71) Applicant: Robert Bosch GmbH, Stuttgart (DE)

(72) Inventors: Alexander Geraldy, Hildesheim (DE); Behzad Benam, Leonberg (DE); Frederik Blank, Ludwigsburg (DE); Kurt Eckert, Ditzingen (DE); Erik Walossek, Giesen (DE); Jan Wolter, Hannover (DE); Jens Schwardmann, Hildesheim (DE); Karl Theo Floess, Heilbronn (DE)

(21) Appl. No.: 17/422,717

(22) PCT Filed: Jan. 23, 2020
(86) PCT No.: PCT/EP2020/051610

§ 371 Date: Jul. 13, 2021

(30) Foreign Application Priority Data
Apr. 5, 2019 (DE) 102019204941.9

(51) Int. Cl. G05D 1/00; H04W 28/24

(52) U.S. Cl. CPC G05D 1/0022; G05D 1/0038; G05D 2201/0213; H04W 28/24; G05D 1/0055

(57) ABSTRACT

A system for teleoperated driving. The system includes a vehicle, a backend, remote control devices. The vehicle, the backend, and the remote control devices are configured to communicate via a mobile communications network.

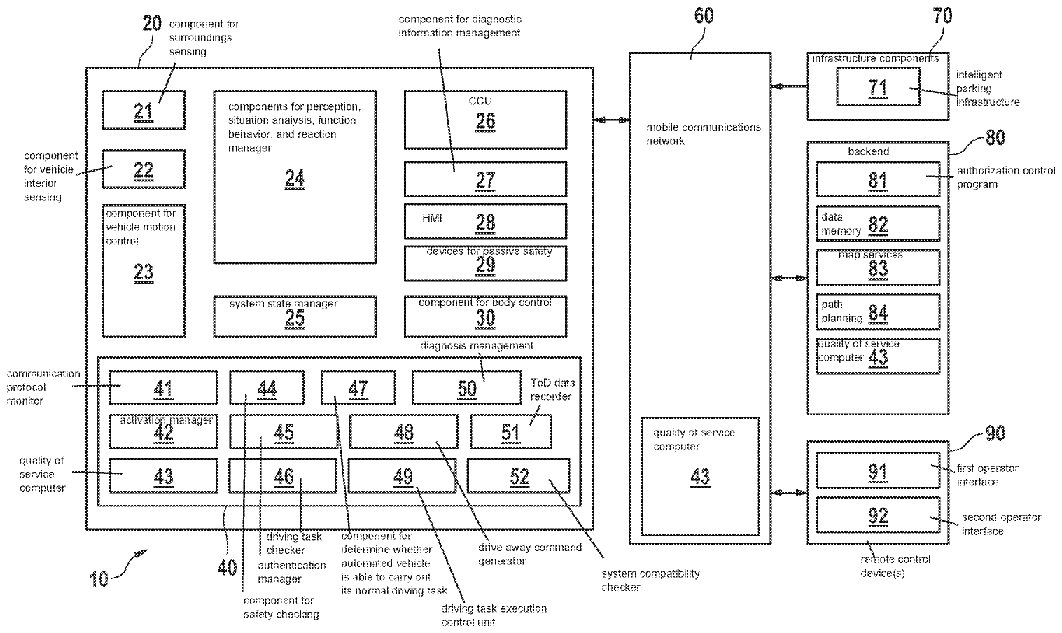

### FIELD

The present invention relates to a system for teleoperated driving (ToD).

### BACKGROUND INFORMATION

Semi-autonomous vehicles according to the related art require a vehicle driving interface (“driver workstation”) as well as a person fit to drive and authorized to drive the vehicle as the vehicle occupant, who is able to take over the driving when needed. The object of numerous research projects involves so-called teleoperated driving, in which the vehicle may be assisted by means of a remote control when managing challenging scenarios—such as detours across dirt roads, alternative and unconventional routes or the like—or the driving task may be temporarily or fully taken over by an external operator in a control center, the so-called operator. Vehicle and control center or their operators are interconnected for this purpose by a mobile communications network having a low latency and a high data rate.

U.S. Pat. No. 9,494,935 B2 describes computer devices, systems and methods for the remote control of an autonomous passenger vehicle. If an autonomous vehicle encounters unexpected surroundings such as, for example, a road construction site or an obstacle, which is unsuited for autonomous operation, the vehicle sensors are able to detect data about the vehicle and the unexpected surroundings, including image data, radar data and LIDAR data, etc. The detected data may be sent to a remote operator. The remote operator may operate the vehicle manually or issue instructions to the autonomous vehicle, which are to be carried out by various vehicle systems. The detected data sent to the remote operator may be optimized in order to save bandwidth, for example, by sending a limited subset of the detected data.

A vehicle described in U.S. Pat. No. 9,767,369 B2 may receive one or multiple image(s) of surroundings of the vehicle. The vehicle may also receive a surroundings map. The vehicle may also compare at least one feature in the images to one or multiple feature(s) in the map. The vehicle may also identify a certain area in the one or the multiple image(s), which corresponds to a portion of the map situated at a threshold distance from the one or the multiple feature(s). The vehicle may also compress the one or the multiple image(s) in order to record a smaller number of details in areas of the images than in the given area. The vehicle may also provide the compressed images to a remote system and, in response thereto, receive operating instructions from the remote system.

Systems and methods described in U.S. Pat. No. 9,465,388 B1 enable an autonomous vehicle to request assistance from a remote operator when the confidence of the vehicle in the operation is low. One exemplary method encompasses the operation of an autonomous vehicle in a first autonomous mode. The method may also encompass the identification of a situation in which a confidence level of an autonomous operation in the first autonomous mode is below a threshold level. The method may furthermore encompass the transmission of a request for assistance to a remote assistant, the request including sensor data representative of a portion of surroundings of the autonomous vehicle. The method may additionally encompass the reception of a response from the remote assistant, the response indicating a second autonomous operating mode. The method may also cause the autonomous vehicle to operate in the second autonomous operating mode according to the response from the remote assistant.

U.S. Pat. No. 9,720,410 B2 describes a further method for remotely assisting autonomous vehicles in predetermined situations.

### SUMMARY

The present invention provides a system for safe teleoperated driving.

An example approach according to the present invention is based in this case on the finding that there are situations that an automated vehicle is unable to independently resolve, and the intervention of a human is necessary in order to overcome this situation or system deficiency, and to bring the entire system into a safe state. This intervention takes place remotely according to the present invention, so that a driver does not necessarily have to be situated in the vehicle.

One advantage of the approach provided for this purpose is in the creation of an architecture and integration of the components of a system for the (functional) safe remote control of the semi-autonomous or fully autonomous vehicle by an operator in a control center. This may be achieved by establishing the safety-critical system components for teleoperated driving and describing an operationally safe and informationally safe (safe and secure) system integration for achieving a corresponding system behavior.

Advantageous refinements of and improvements on present invention are possible with the measures disclosed herein. Thus, additional optional components may be provided for enabling or improving the tasks of remote sensing and remote control. In this way, a system and the associated system architecture for teleoperated driving are created, which integrate all relevant system components in order to carry out a remote sensing and remote control of the driving operation in a functionally safe way while taking the properties of a mobile communications link and of various operating modes into account.

### BRIEF DESCRIPTION OF THE DRAWINGS

Exemplary embodiments of the present invention are represented in the figures and are described in greater detail below.

The figure shows a block diagram of a system according to one specific embodiment of the present invention.

### DETAILED DESCRIPTION OF EXAMPLE EMBODIMENTS

The figure shows at a high level of abstraction a ToD vehicle 20, a, for example, fifth generation 5G mobile communications network 60, a backend 80, remote control devices 90, infrastructure components 70 and the most important components included in each case. Thus, a component 21 for surroundings sensing collects all pieces of information relating to the surroundings of ToD vehicle 20, for example, with the aid of radar sensors, camera sensors, ultrasonic sensors, LIDAR sensors, speed sensors, an inertial navigation system (inertial measurement unit, IMU) and a crash detector. A component 22 for vehicle interior sensing utilizes all sensors in vehicle 20 for driver and passenger monitoring, for example, driver activity sensor and seat occupation information. A component 23 for vehicle motion control is responsible for the vehicle motion and vehicle stability.

Autonomous driving (AD) and driver assistance system functions (advanced driver assistance systems, ADAS) should also be mentioned. Corresponding components 24 relate, for example, to the perception, the situation analysis, the function behavior, the reaction manager as well as the prediction.

All system states are handled in a system state manager 25. In this system two operating modes are considered:
1. a remote control, in which an operator guides or drives automated vehicle 20 without direct visual contact, so that the pieces of vehicle information and the vehicle surroundings for the operator must be transmitted and displayed and
2. a remote control, in which an operator guides or drives automated vehicle 20 with direct visual contact, so that the operator has the possibility of directly controlling the vehicle status and the surroundings.

A telematics unit (connectivity control unit, CCU 26) forms the interface of system 10 for communicating via 5G mobile communications network 60. A component 27 for diagnostic information management is responsible for the general system diagnosis; an onboard human-machine interface, HMI 28, forms the interface to the driver or to the passenger of vehicle 20.

Devices 29 for passive safety encompass, for example, airbag, so-called pre-crash identification and event data recorder. A component 30 for body control is responsible for power supply, communication in vehicle 20, vehicle access systems and lighting system. Further safety-relevant components 40 are responsible for all safety-relevant objectives of teleoperated driving.

The operation of system 10 in this case takes into account the following safety objectives:
1. the identification of the communication errors on both sides (sender, receiver) in order to bring system 10 into a safe state within a predefined tolerance time t_{c}.
2. the identification of the compatibility of all system elements in order to bring system 10 into a safe state within tolerance time tₒ,
3. the identification of unauthorized accesses to system 10 in order to bring system 10 into a safe state within tolerance time tₛ,
4. the identification of crash data, pre-crash data or other relevant data for a safe ToD function and the sending upon request to the control room,
5. the detection of objects in the vicinity—for example, at arbitrary angles at a distance of up to 50 cm—of vehicle 20 and underneath vehicle 20, in order to report these to the operator, as well as
6. the detection of system limits and response within a predefinable time span t_{b} when they are violated.

Various safety components are used to achieve these safety objectives. To achieve safety objective 1, for example, a communication protocol monitor 41 monitors the 5G communication line under all aforementioned aspects of the communication error (cf. ISO 26262-6, D.2.4) and reports the error, if necessary to system state manager 25.

To achieve safety objective 6, a component 44 is used for system checking before the transfer to remote control devices 90 and the operator. No transfer takes place if a situation is undefined. The check of the system limit after the transfer from the operator to automated vehicle 20 takes place via a corresponding component 47 for determining whether automated vehicle 20 is able to carry out its normal driving task.

The following diagnosis management 50 is also used to achieve safety objective 6: a ToD diagnosis (for the autonomy levels 2 through 5 according to SAE J3016) is triggered before the activation of the ToD function. This diagnosis includes, in addition to a check of the ToD functionality in the narrower sense (sensor availability, brakes, etc.), the ascertainment of the possible ToD control (maneuvering, path planning, behavior planning, speed, steering, reversing, etc.). The auto repair shop or the auto manufacturer should be contacted if the activation of the ToD function is not possible.

Finally, an activation manager 42 is also provided for achieving safety objective 6. In this case, all important and available safety-related parameters such as the quality of service, pQoS, perceived by the user and the path complexity, should be used for the activation in order to reduce the complexity of the safety components in vehicle 20.

An authentication manager 45 is used to achieve safety objective 3. The authentication of the complete safety chain in this case takes the following aspects into consideration:
a list of the authorized operators having access to vehicle 20,
availability of the correct software and hardware,
operator authorization
control room
backend (80), as well as
communication channels and servers (a redirection to other servers or channels should be avoided).

A drive away command generator 48 is used to achieve safety objective 5. In this regard, the drive away by automated vehicle 20 is to be checked and the operator is to be informed thereof, because vehicle 20 may not move in the event of violations. An underbody vehicle monitoring, all-around vehicle monitoring in an open space of 50 cm, check of the local weather conditions (with respect to temperature, ice-covered road, etc.) as well as the available sensor performance (visibility of the sensor, blindness, etc.), in particular, are considered.

A ToD data recorder 51 is used to achieve safety objective 4: all ToD-relevant data, for example, timestamp of the transfer, operator ID, driving style of the operator, applied communication channel, pieces of authorization information and any crashes are recorded locally by this component and transmitted upon request to the server.

To achieve safety objective 1, the received network QoS value is to be checked by a quality of service computer 43 and forwarded to the associated safety components. It is incumbent upon a driving task checker 46 to check whether the driving task requested by the operator is executable and violates no safety objectives relating to the ToD and AD functions, whereas a driving task execution control unit 49 ensures the monitoring of the driving task and the updating of the operator about the progress. In the case of an error, the operator may control system 10.

Finally, a system compatibility checker 52 is used to achieve safety objective 2. To be considered here is the check of the compatibility of the hardware and software in automated vehicle 20, in backend 80, of the control room and of the protocols carried out on the communication channels before the activation of the ToD and during its execution.

According to one alternative mode of operation, the mentioned safety objectives may be differently assessed based on a hazard analysis and risk assessment, HARA, according to ISO 26262, ISO 25119 or DIN EN 16590. Thus, the highest automotive safety integrity level, ASIL, defined for the entire functionality is standard for a system 10 according to the present invention.

Example embodiments of the present invention are set forth in the following numbered Paragraphs:

Paragraph 1. A system (10) for teleoperated driving, characterized by the following features:
the system (10) includes a vehicle (20), a backend (80), remote control devices (90) and
the vehicle (20), the backend (80) and the remote control devices (90) are configured to communicate with one another via a mobile communications network (60).

Paragraph 2. The system (10) as recited in Paragraph 1, characterized by the following features:
the vehicle (20) includes safety-relevant components (40) and
the components (40) include a communication protocol monitor (41), a system compatibility checker (52) and a driving task checker (46).

Paragraph 3. The system (10) as recited in Paragraph 2, wherein the components (40) further include at least one of the following:
first component (44) for system checking before a transfer to the remote control devices (90),
second component (47) for system checking after the transfer,
component (50) for diagnosis management,
an activation manager (42),
an authentication manager (45),
a drive away command generator (48),
a data recorder (51),
a quality of service computer (43) or
a driving task execution control unit (49).

Paragraph 4. The system (10) as recited in Paragraph 3, characterized by the following features:
the quality of service computer (43) is configured to check a quality of service of the mobile communications network (60) and
the quality of service computer (43) is further configured to communicate the checked quality of service to the safety-relevant components (40).

Paragraph 5. The system (10) as recited in one of Paragraphs 2 through 4, wherein the vehicle (20) includes at least one of the following:
component (21) for surroundings detection,
component (22) for vehicle interior detection,
component (23) for vehicle motion control,
autonomous driving and driver assistance system functions (24),
a system state manager (25),
a telematics unit (26) for connecting with the mobile communications network (60),
component (27) for diagnosis information management,
an onboard human-to-machine interface (28),
passive safety devices (29) or
component (30) for body control.

Paragraph 6. The system (10) as recited in Paragraph 5, characterized by the following features:
the communication protocol monitor (41) is configured to identify communication errors during communication via the mobile communications network (60) and
the communication protocol monitor (41) is further configured to report the identified communication errors to the system state manager (25).

Paragraph 7. The system (10) as recited in Paragraph 6, wherein the identification of the communication errors takes place based at least on one of the following causes or effects:
a repetition of pieces of information,
a loss of pieces of information,
a delay of pieces of information,
an insertion of pieces of information,
an unauthorized or erroneous addressing of pieces of information,
an erroneous sequence of pieces of information,
a distortion of pieces of information,
an asymmetrical piece of information sent by one sender to multiple receivers,
a piece of information received from a sender by merely a subset of provided receivers or
a blocking access to a communication channel.

Paragraph 8. The system (10) as recited in one of Paragraphs 1 through 7, wherein the backend (80) includes at least the following:
an authorization control program (81),
a data memory (82),
map services (83) or
component (84) for path planning.

Paragraph 9. The system (10) as recited in one of Paragraphs 1 through 8, wherein the remote control devices (90) include at least one of the following:
a first operator interface (91) for operating the vehicle (20) out of sight and
a second operator interface (92) for operating the vehicle (20) within sight.

Paragraph 10. The system (10) as recited in one of Paragraphs 1 through 9, characterized by the following features:
the system (10) further includes infrastructure components (70) and
the infrastructure components (70) include an intelligent parking infrastructure (71).

1-10. (canceled)

11. A system for teleoperated driving, comprising:
a vehicle;
a backend; and
remote control devices;
wherein the vehicle, the backend, and the remote control devices are configured to communicate with one another via a mobile communications network.

12. The system as recited in claim 11, wherein the vehicle includes safety-relevant components, the components including a communication protocol monitor, a system compatibility checker, and a driving task checker.

13. The system as recited in claim 12, wherein the components further include at least one of the following:
a first component configured for system checking before a transfer to the remote control devices, and/or
a second component configured for system checking after the transfer, and/or
a component for diagnosis management, and/or
an activation manager, and/or
an authentication manager, and/or
a drive away command generator, and/or
a data recorder, and/or
a quality of service computer, and/or
a driving task execution control unit.

14. The system as recited in claim 13, wherein:
the quality of service computer is configured to check a quality of service of the mobile communications network, and
the quality of service computer is further configured to communicate the checked quality of service to the safety-relevant components.

15. The system as recited in claim 12, wherein the vehicle includes at least one of the following:
a component for surroundings detection, and/or
a component for vehicle interior detection, and/or
a component for vehicle motion control, and/or
autonomous driving and driver assistance system functions,
a system state manager, and/or
a telematics unit for connecting with the mobile communications network, and/or
component for diagnosis information management, and/or
an onboard human-to-machine interface, and/or
passive safety devices, and/or
component for body control.

16. The system as recited in claim 15, wherein:
the communication protocol monitor is configured to identify communication errors during communication via the mobile communications network; and
the communication protocol monitor is further configured to report the identified communication errors to the system state manager.

17. The system as recited in claim 16, wherein the identification of the communication errors takes place based at least on one of the following causes or effects:
a repetition of pieces of information, and/or
a loss of pieces of information, and/or
a delay of pieces of information, and/or
an insertion of pieces of information, and/or
an unauthorized or erroneous addressing of pieces of information, and/or
an erroneous sequence of pieces of information, and/or
a distortion of pieces of information, and/or
an asymmetrical piece of information sent by one sender to multiple receivers, and/or
a piece of information received from a sender by merely a subset of provided receivers, and/or
a blocking access to a communication channel.

18. The system as recited in claim 11, wherein the backend includes at least the following:
an authorization control program, and/or
a data memory, and/or
map services, and/or
a path planning component.

19. The system as recited in claim 11, wherein the remote control devices include at least one of the following:
a first operator interface configured to operate the vehicle out of sight, and/or
a second operator interface configured to operate the vehicle within sight.

20. The system as recited in claim 11, wherein the system further includes infrastructure components, and the infrastructure components include an intelligent parking infrastructure.
